(19) United States
(12) Patent Application Publication
(10) Pub. No.: US 2005/0260886 A1
(43) Pub. Date: Nov. 24, 2005

(54) Fuse block cover

(76) Inventor: Leonard Persits, Highland Park, IL (US)

Correspondence Address: Edward L. Bishop;Wallenstein Wagner & Rockey, Ltd., 53rd Floor, 311 South Wacker Drive, Chicago, IL, 60606-6630, US

(21) Appl. No.: 10/849,997

(22) Filed: May 20, 2004

(51) Int. Cl. H01R 13/52

(52) U.S. Cl. 439/521

(57) ABSTRACT

A touch-proof fuse block cover is disclosed. The fuse block cover has a body with a first end and a second end. One or more end covers are connected to the body for covering open ends of a fuse block. One or more ledges are integral with and extend from the first end, the second end, or both, wherein an upward force applied to an underside of the ledge(s) disengages the fuse block cover from the fuse block. A clip is connected to and extends from the fuse block. The clip has a barbed end that removably engages a recess in the body of the fuse block cover when the fuse block cover is in place on the fuse block, such that the fuse block cover cannot be easily removed without the use of a tool.

### TECHNICAL FIELD

This invention relates to a fuse block cover for a fuse block, and in particular, to a fuse block cover that provides protection from electrical shock and cannot be easily removed without the use of a tool.

### BACKGROUND

Fuse block covers are well known in the art. Fuse block covers are generally used to cover and protect fuses, and to prevent electrical shock. While fuse block covers according to the prior art provide a number of advantageous features, they nevertheless have certain limitations. The present invention seeks to overcome certain of these limitations and other drawbacks of the prior art, and to provide new features not heretofore available.

### SUMMARY

The present invention generally provides a fuse block cover which provides protection from electrical shock and cannot be easily removed without the use of a tool. An embodiment of the fuse block cover comprises a body having a first end and a second end. End covers or flaps are attached to each end of the body for covering open portions of the fuse block.

According to another embodiment, a clip is connected to and extends from the fuse block. The clip has a barbed end that removably engages a recess in the body of the fuse block cover when the fuse block cover is in place on the fuse block, such that the fuse block cover cannot be easily removed without the use of a tool.

There are other advantages and features that will be more readily apparent from the following detailed description of the preferred embodiment of the invention, the drawings, and the appended claims.

### BRIEF DESCRIPTION OF THE DRAWINGS

In the accompanying drawings that form part of the specification, and in which like numerals are employed to designate like parts throughout the same,

FIG. 1 is a perspective view of one embodiment of a fuse block cover in accordance with the present invention;

FIG. 2 is a side elevation view of the fuse block cover of FIG. 1;

FIG. 3 is a perspective view of a fuse block for use with the present invention;

FIG. 4 is a perspective view of two fuse block covers of the present invention in place atop the fuse block of FIG. 3;

FIG. 5 is a top plan view of the fuse block of FIG. 4 with one fuse cover removed, and thus depicting an open compartment for installing a fuse; and,

FIG. 6 is a top plan view of the fuse block of FIG. 5 with a fuse installed in the compartment having the fuse cover removed.

### DETAILED DESCRIPTION

While this invention is susceptible to embodiments in many different forms, this specification and the accompanying drawings disclose only preferred forms as examples of the invention. The invention is not intended to be limited to the embodiments so described, however. The scope of the invention is identified in the appended claims.

Turning to the figures, and initially to FIG. 1, there is shown a fuse block cover 10 for covering a barrel type fuse 44. While the barrel type fuse 44 is used to exemplify the principles of the present invention in one embodiment, the fuse block cover 10 of the present invention can be used to cover any type of fuse, as will be readily understood by one of ordinary skill in the art. As will also be appreciated by those having ordinary skill in the art, the cover 10 is touch-proof because it provides protection from electrical shock and requires a tool for easy removal from the fuse block.

As shown, the cover 10 has a body 12. The body 12 has a first end 14 and a second end 16. The body 12 has a planar surface 13 with a longitudinal axis X-X and a lateral axis Y-Y of sufficient length to cover the barrel type fuse 44. A support or spine 18 extends from the first end 14 to the second end 16 along the longitudinal axis X-X. The fuse block cover 10 is formed of a dielectric material. For example, the fuse block cover 10 can be formed of a polymer.

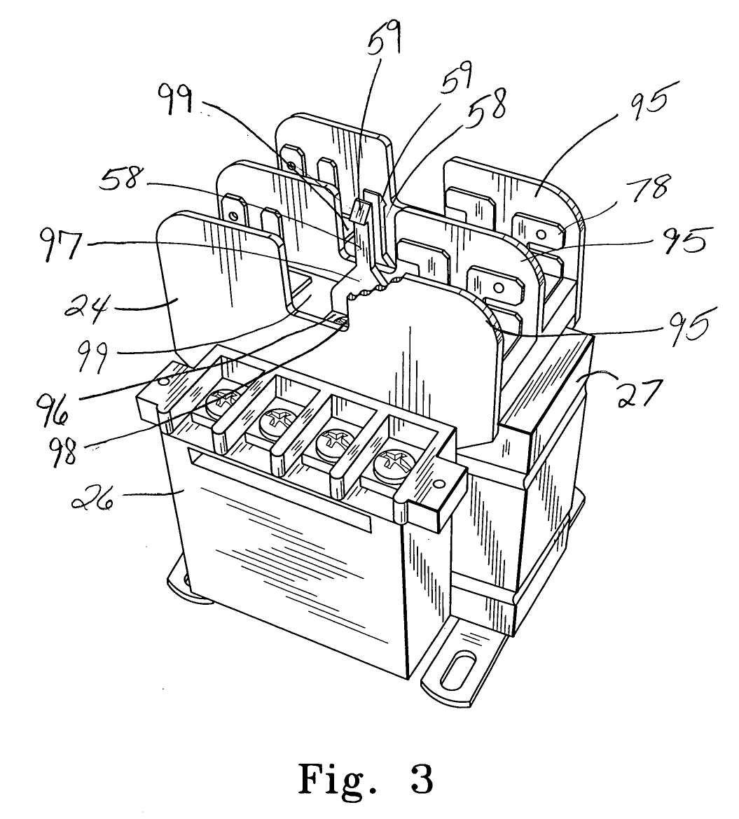

As described in detail further herein, and turning to FIG. 3, the cover 10 (not shown) provides a lid or top for a compartment 99 within a fuse block 24 wherein the compartment receives an electrical fuse. Although two compartments 99 are shown in FIG. 3, the fuse block 24 can have only one compartment 99 or any number of compartments greater than one (i.e., plurality). Moreover, the fuse block 24 can be mounted, in a conventional manner, to any suitable structure or surface such as an electrical component, a covering or casing covering all or a portion of an electrical component, a lamination, a circuit board, a surface within a fuse box, an electrical panel, or the like.

As shown in FIGS. 1, 2, and 4, the touch-proof fuse block cover 10 has a first end cover 20 connected to the body 12 for covering an open end of the compartment 99 within the fuse block 24. A second end cover 22 is connected to the body 12 for covering another open end of the compartment 99 within the fuse block 24, wherein the first end cover 20 is connected to the first end 14 and the second end cover 22 is connected to the second end 16. The first end cover 20 and the second end cover 22 are integral with the body 12.

As shown in FIGS. 3, 4, 5, and 6, and previously indicated above, the fuse block 24 can be mounted on a transformer lamination 27 or any other device using screws, bolts 98 and nuts 100, glue or any other conventional mounting means known by those having ordinary skill in the art. The fuse block 24 is a safety device made of an electrically insulative material (e.g., a polymer) that provides a partial covering to protect individuals from inadvertent contact with electrically charged or powered contacts. Moreover, the fuse block 24 receives one or more fuses 44 that protect circuits, such as the transformer, from drawing excessive current, voltage, or power. In an embodiment, each fuse 44 has a metallic strip or fuse element 52 that melts when the current exceeds a specific amperage, thereby opening the circuit.

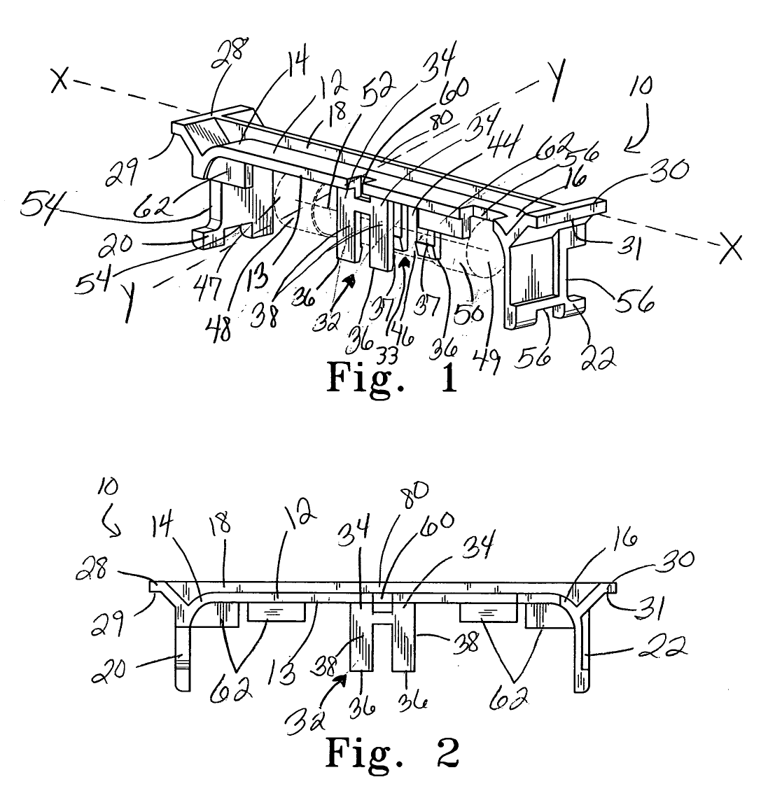

Turning back to FIGS. 1 and 2, the cover 10 has a first ledge or tab 28 that is integral with and extends from the first end 14. As explained in detail further herein, an upward force applied to an underside 29 of the first ledge or tab 28 assists in disengaging the fuse block cover 10 from the fuse block 24. A second ledge or tab 30 can also be integral with and extend from the second end 16. Similarly, an upward force applied to an underside 31 of the second ledge or tab 30 assists in disengaging the fuse block cover 10 from the fuse block 24. The support or spine 18 provides rigidity to prevent unwanted flexing of the body 12 and the ledges or tabs 28,30.

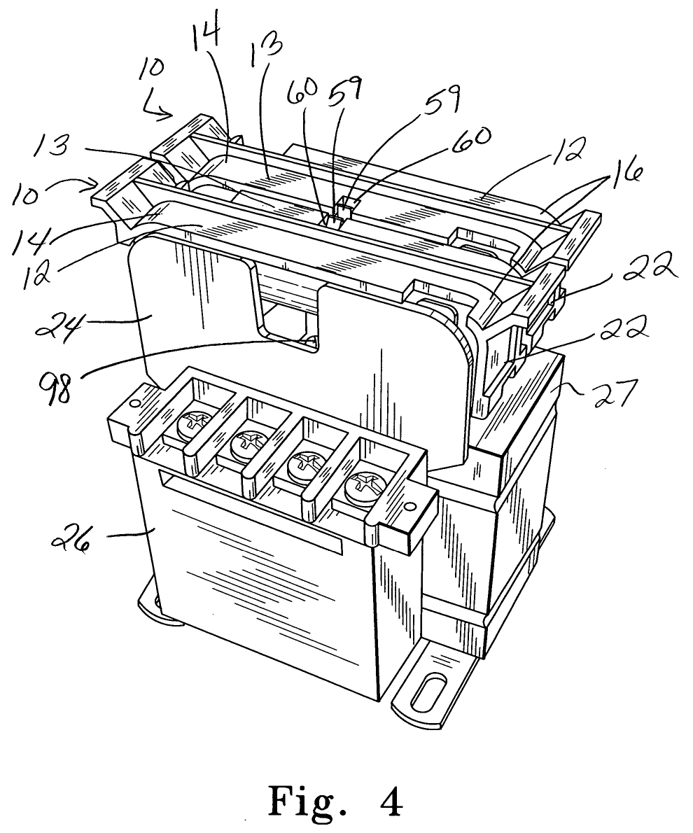

As shown in FIGS. 3 and 4, two clips 58 are connected to and extend from the fuse block 24, such that there is one clip 58 for each compartment 99 and its associated fuse block cover 10. Each clip 58 is made of a dielectric resilient material (e.g., polymer or the like) and has a base portion 96 with an integrally connected arm 97 extending perpendicularly therefrom. The base 96 has an aperture (not shown) for receiving the shaft of a screw or bolt 98 used for securing the clip 58 to the fuse block. Each clip 58 is positioned perpendicularly to the planar surface 13 of the body 12 when the fuse block cover 10 is in place on the fuse block 24. The clip 58, and in particular the arm 97, has a barbed end 59 that removably engages a recess 60 in the body 12 of the fuse block cover 10 when the fuse block cover is in place on the fuse block 24. This helps to hold the fuse block cover 10 in place on the fuse block 24, such that the fuse block cover 10 cannot be easily removed without the use of a tool such as a screw driver of other device for pushing the barbed end 59 from the recess 60. As will be appreciated by those having ordinary skill in the art, any number of clip 58 and recess 60 combinations can be used without departing from the spirit of the invention. Moreover, the barbed end 59 can be of a form other than a barb, such as a notch, protuberance or other catch-like structure that engages the cover 10 and prevents its easy extraction from the fuse block 24 without the use of a tool. Preferably, the barbed end 59 of the clip 58 does not engage the recess 60 in the cover 10 unless the cover is properly fitted over the opening to the compartment 99.

In an alternative embodiment, the clips 58 can be omitted. In this embodiment, the cover 10 is still secured over the associated compartment 99 by coupling the cover to the fuse 44 mounted within the compartment as described in detail further herein. Accordingly, the cover provides electrical shock protection from active components or terminals within the fuse block compartment 99. However, in this alternative embodiment, the cover is not considered touch-proof because the cover can be easily removed without the use of a tool. Moreover, if a fuse is not contained in the compartment 99 and the clips 58 are omitted, then the cover cannot be secured over the opening to the compartment for providing protection from electrically active components or terminals contained therein.

One or more stops 62 extend perpendicularly from the planar surface 13 on one or more edges of the body 12. When the cover 10 is attached to the fuse block 24, the one or more stops 62, in association with the sidewalls 95 of the compartment being covered, prevent yaw of the fuse block cover 10. In FIGS. 1 and 2, four stops 62 are shown, two on each edge of the body 12.

As previously stated, in a preferred embodiment, the fuse block 24 shown in FIGS. 3, 4, 5, and 6 holds two conventional barrel type fuses 44, so that two fuse block covers 10 are needed to cover the fuses 44. As known by those having ordinary skill in the art and shown in FIG. 1, the barrel type fuse 44 comprises a generally cylindrical member 46 with a first fuse end 47 and a second fuse end 49. The generally cylindrical member 46 may be formed of glass or any other suitable material known by those having ordinary skill in the art. A first metallic cap 48 is on the first fuse end 47, and a second metallic cap 50 is on the second fuse end 49. The metallic strip or fuse element 52 is housed within the generally cylindrical member 46 and is coupled to the first and second metallic caps 48,50. Both the metallic caps 48,50 and the metallic strip 52 can be formed of a metal or a metal alloy.

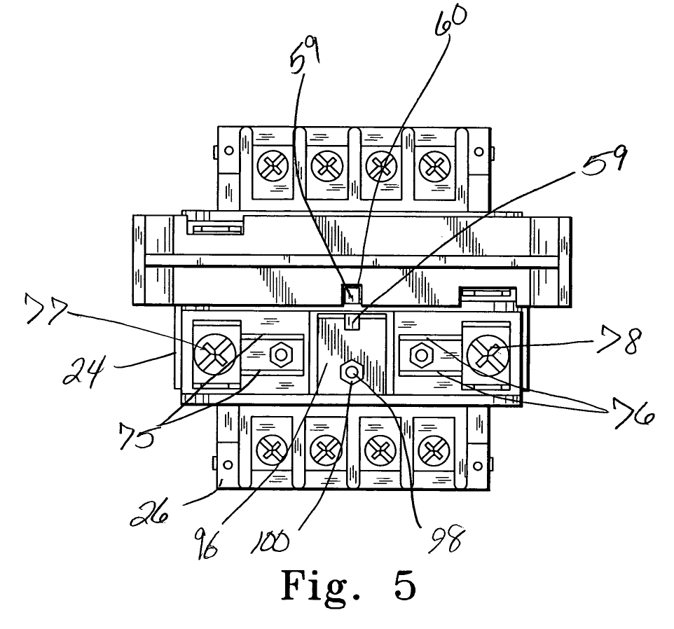

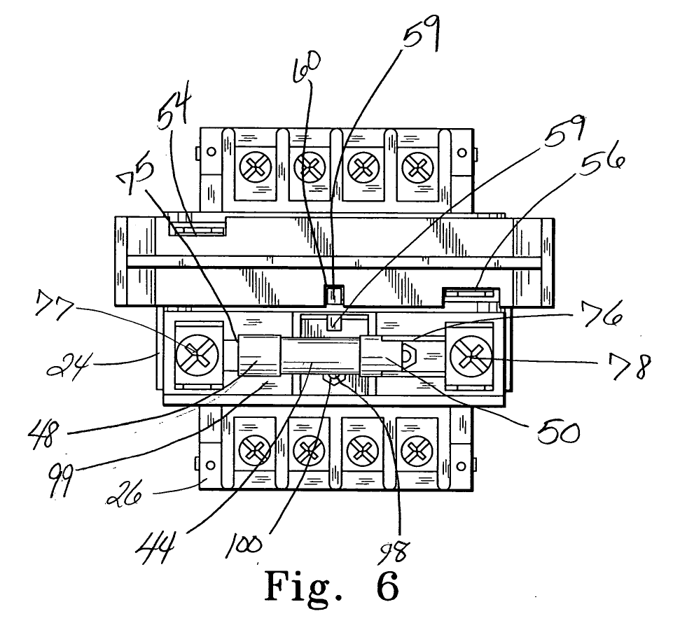

As shown in FIG. 6, when the barrel type fuse 44 is properly inserted in the fuse block 24, the first metallic cap 48 is clipped into a first fuse holder 75 and coupled to a first terminal 77, and the second metallic cap 50 is clipped into a second fuse holder 76 and coupled to a second terminal 78. The first and second fuse holders 75,76, which are shown without the fuse 44 in place in FIG. 5, removably secure the fuse 44 within the fuse compartment 99.

As shown in FIGS. 1 and 6, when the fuse block cover 10 is in place on the fuse block 24, one or more first indentations 54 in the body 12 are in positional agreement with either the first metallic cap 48 or the first terminal 77, and one or more second indentations 56 in the body 12 are in positional agreement with either the second metallic cap 50 or the second terminal 78. As such, the positioning of the first and second indentations 54,56 allows access to the terminals 77,78 with a connector (not shown) such as, for example, a spade lug. Preferably, the indentations 54,56 are sized so that no part of the human body can easily fit through to touch the active components such as the terminals 77,78 or fuse 44 contained in the compartment 99. This is a safety precaution that lessens the risk of electrical shock to humans. Any number of indentations 54,56 can be used without departing from the spirit of the invention. The indentations 54,56 are sized or dimensioned to prevent a generally cylindrical object, such as a finger (not shown), from passing through the indentations. In a preferred embodiment, the indentations 54,56 are sized to prevent an object of about 12 millimeters in diameter from passing therethrough. For instance, the indentations 54,56 can rectangular and about ½ inches in length and about 3/16 inches in width, based on the connector used in coupling to the terminals 77,78. However, the indentations can have other lengths and widths without departing from the spirit of the invention.

As previously stated, in an alternative embodiment, the clips 58 can be omitted and thus the cover 10 is secured over the associated compartment 99 by coupling the fuse cover 10 to the fuse 44 mounted within the compartment 99. As shown in FIG. 1, coupling of the fuse cover 10 to the fuse 44 is achieved using opposing fuse grippers 32 and 33. At least one pair of opposing fuse grippers 32 and 33 is connected to the body 12 about the lateral axis Y-Y of the cover 10 and about each side of the longitudinal axis X-X. The opposing fuse grippers 32 and 33 extend perpendicularly from the planar surface 13 of the body 12.

As shown in FIGS. 1 and 2, each fuse gripper 32,33 preferably comprises a proximal end 34 connected to the body 12, and a pair of arms 38 with each arm having a distal end 36 with a protrusion 37 opposite the proximal end 34. The protrusion 37 is typically a barb, as shown in FIG. 1, but can be any kind of protrusion known by those having ordinary skill in the art or, in an alternative design, the arms 38 can have a notch or indentation for holding the fuse. The arms or middle portion 38 of each fuse gripper 32,33 lies between the gripper's proximal end 34 and distal end 36, wherein the middle portions 38 and the distal ends 36 of the opposing fuse grippers 32 and 33 are in spaced relationship to removably engage the barrel type fuse 44. Preferably, the fuse grippers 32 and 33 are made of a resilient material, so that the barrel type fuse 44 can be easily pushed into place between the opposing fuse grippers and detachably held in the middle portions 38 of the fuse grippers by the protrusions 37 on the distal ends 36. The opposing fuse grippers 32 and 33 are preferably connected to the body 12 at or near a midpoint 80 between the first end 14 and the second end 16. Preferably, the opposing fuse grippers 32 and 33 are integral with the body 12.

The opposing fuse grippers 32 and 33 removably engage the barrel type fuse 44 when the fuse block cover 10 is snapped into place on the fuse block 24. In an embodiment, upon removal of the cover 10, the fuse 44 remains in place in the compartment 99 of the fuse block 24, since the force exerted by the fuse grippers 32 and 33 is not sufficient to overcome the force exerted by the first and second fuse holders 75,76 that secure the fuse 44 within the fuse compartment 99.

The opposing fuse grippers 32 and 33 can also be used to safely install the fuse 44 in the compartment 99 of the fuse block 24. The user places the fuse 44 in the opposing fuse grippers 32, as shown in FIG. 1, and then positions the fuse block cover 10 over the compartment 99 of the fuse block 24 as shown in FIGS. 4, 5, and 6. This allows the fuse 44 to be installed safely, without the risk of electrical shock to the user.

In an alternative embodiment, not shown, each fuse gripper 32,33 can have only a single arm 38 for engaging the barrel type fuse 44. Although also not shown, each fuse gripper 32,33 can include any number of additional arms 38 without departing from the spirit of the invention. Several alternative embodiments have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first” and “second” as used herein are intended for illustrative purposes only and do not limit the embodiments in any way.

Numerous variations and modifications of the embodiments described above may be effected without departing from the spirit and scope of the novel features of the invention. No limitations with respect to the specific system illustrated herein are intended or should be inferred.

1. A fuse block cover comprising:
a body having a first end and a second end;
a first end cover connected to the first end of the body for covering at least a portion of an opening in a fuse block;
a pair of opposing fuse grippers connected to the body, each fuse gripper comprising:
a proximal end connected to the body;
a distal end with a protrusion opposite the proximal end; and,
a middle portion between the proximal end and the distal end, wherein the middle portions and the distal ends of the opposing fuse grippers are in spaced relationship to removably engage a fuse.

2. The fuse block cover of claim 1 wherein the protrusion is a barb.

3. The fuse block cover of claim 1 wherein the fuse block is mounted on a structure and the fuse comprises:
a generally cylindrical member having a first fuse end and a second fuse end;
a first metallic cap on the first fuse end;
a second metallic cap on the second fuse end; and,
a metallic strip housed within the generally cylindrical member and coupled to the first and second metallic caps.

4. The fuse block cover of claim 3 further comprising:
a first indentation in the body in positional agreement with the first metallic cap; and,
a second indentation in the body in positional agreement with the second metallic cap.

5. The fuse block cover of claim 1 further comprising one or more indentations in the body wherein each indentation is sized to prevent an object having a diameter of about 12 millimeters from passing through the indentation when the cover is installed on the fuse block.

6. The fuse block cover of claim 1 wherein the fuse block is mounted on a structure associated with an electrical panel or a fuse box.

7. The fuse block cover of claim 1 wherein the fuse block is mounted on a structure associated with a transformer.

8. The fuse block cover of claim 1 further comprising:
a second cover connected to the second end of the body for covering at least a portion of the opening in the fuse block.

9. The fuse block cover of claim 8 wherein the first end cover and the second end cover are integrally connected to the body.

10. The fuse block cover of claim 1 wherein the fuse grippers are integral with the body.

11. The fuse block cover of claim 1 wherein the fuse grippers are connected to the body at a midpoint between the first end and the second end.

12. The fuse block cover of claim 1 further comprising:
a ledge integral with and extending from the first end, wherein an upward force applied to an underside of the ledge disengages the fuse block cover from the fuse block.

13. The fuse block cover of claim 1 formed of a dielectric material.

14. The fuse block cover of claim 1 further comprising:
a clip having a barbed end, the clip extending from the fuse block; and,
a recess in the body of the fuse block cover, wherein the barbed end of the clip removably engages the recess in the body when the fuse block cover is in place on the fuse block.

15. A fuse block cover comprising:
a body having a first end and a second end;
a first end cover connected to the body for covering at least a portion of an opening in a fuse block;
a first pair of opposing fuse grippers connected to the body; and,
a second pair of opposing fuse grippers connected to the body, each of the fuse grippers having a proximal end connected to the body, a distal end with a protrusion opposite the proximal end, and a middle portion between the proximal end and the distal end, wherein the middle portions and the distal ends of the first pair of opposing fuse grippers and the second pair of opposing fuse grippers are in spaced relationship to removably engage a fuse.

16. The fuse block cover of claim 15 wherein the protrusion is a barb.

17. The fuse block cover of claim 15 wherein the fuse block is mounted on a structure and the fuse comprises:
a generally cylindrical member having a first fuse end and a second fuse end;
a first metallic cap on the first fuse end;
a second metallic cap on the second fuse end; and,
a metallic strip housed within the generally cylindrical member and coupled to the first and second metallic caps.

18. The fuse block cover of claim 17 further comprising:
a first indentation in the body in positional agreement with the first metallic cap; and,
a second indentation in the body in positional agreement with the second metallic cap.

19. The fuse block cover of claim 15 further comprising one or more indentations in the body wherein each indentation is sized to prevent an object having a diameter of about 12 millimeters from passing through the indentation when the cover is installed on the fuse block and each indentation is in positional agreement with a terminal within the fuse block.

20. The fuse block cover of claim 15 wherein the fuse block is mounted on a structure associated with an electrical panel or fuse box.

21. The fuse block cover of claim 15 wherein the fuse block is mounted on a structure associated with a transformer.

22. The fuse block cover of claim 15 further comprising:
a second end cover connected to the body for covering at least a potion of the opening in the fuse block.

23. The fuse block cover of claim 22 wherein the first end cover and the second end cover are integrally connected to the body.

24. The fuse block cover of claim 15 wherein the fuse grippers are integral with the body.

25. The fuse block cover of claim 15 further comprising:
a ledge integral with and extending from the first end, wherein an upward force applied to an underside of the ledge disengages the fuse block cover from the fuse block.

26. The fuse block cover of claim 15 formed of a dielectric material.

27. The fuse block cover of claim 15 further comprising:
a clip having a barbed end, the clip extending from the fuse block; and,
a recess in the body of the fuse block cover, wherein the barbed end of the clip removably engages the recess in the body when the fuse block cover is in place on the fuse block.

28. A fuse block cover comprising:
a body having a first end and a second end;
first and second end covers connected to body for covering at least a portion on an opening in a fuse block;
a first ledge integral with and extending from the first end;
a second ledge integral with and extending from the second end, wherein an upward force applied to either of an underside of the first ledge or an underside of the second ledge disengages the fuse block cover from the fuse block;
a first pair of opposing fuse grippers connected to the body; and,
a second pair of opposing fuse grippers connected to the body, each of the fuse grippers having a proximal end connected to the body, a distal end with a protrusion opposite the proximal end, and a middle portion between the proximal end and the distal end, wherein the middle portions and the distal ends of the first pair of opposing fuse grippers and the second pair of opposing fuse grippers are in spaced relationship to removably engage a fuse.

29. The fuse block cover of claim 28 wherein the protrusion is a barb.

30. The fuse block cover of claim 28 wherein the first end cover and the second end cover are integrally connected to the body.

31. The fuse block cover of claim 28 wherein the fuse grippers are integral with the body.

32. The fuse block cover of claim 28 formed of a dielectric material.

33. The fuse block cover of claim 28 wherein the fuse comprises:
a generally cylindrical member having a first fuse end and a second fuse end;
a first metallic cap on the first fuse end;
a second metallic cap on the second fuse end; and,
a metallic strip housed within the generally cylindrical member and coupled to the first and second metallic caps.

34. The fuse block cover of claim 33 further comprising:
a first indentation in the body in positional agreement with the first metallic cap; and,
a second indentation in the body in positional agreement with the second metallic cap.

35. The fuse block cover of claim 28 further comprising:
a clip having a barbed end, the clip extending from the fuse block; and,
a recess in the body of the fuse block cover, wherein the barbed end of the clip removably engages the recess in the body when the fuse block coyer is in place on the fuse block.

36. The fuse block cover of claim 28 further comprising one or more indentations in the body wherein each indentation is sized to prevent an object having a diameter of about 12 millimeters from passing through the indentation when the cover is installed on the fuse block.

37. The fuse block cover of claim 28 wherein the fuse block cover is mounted on a structure associated with an electrical panel or a fuse box.

38. The fuse block cover of claim 28 wherein the fuse block is mounted on a structure associated with a transformer.
